(19) United States
(12) Patent Application Publication
(10) Pub. No.: US 2026/0076307 A1
(43) Pub. Date: Mar. 19, 2026

(54) AIR BLOWER SYSTEMS AND METHODS FOR USE

(71) Applicant: Ag Manufactured Products LLC, Fort Recovery, OH (US)

(72) Inventors: Joshua M. Overman, Fort Recovery, OH (US); Dustin B. Overman, Saint Henry, OH (US)

(21) Appl. No.: 19/328,878

(22) Filed: Sep. 15, 2025

Related U.S. Application Data
(60) Provisional application No. 63/695,575, filed on Sep. 17, 2024.

(51) Int. Cl. A01F 12/48

(52) U.S. Cl. CPC A01F 12/48

(57) ABSTRACT

Air blower systems are disclosed including a blower, a vacuum component, and an air curtain component. The blower can be connected to the vacuum component to exert a suction force over a vacuum line in fluid communication with a grain cart auger to facilitate removal of chaff as grain is unloaded from the grain cart. The blower can also be connected to the air curtain component having a curtain pipe defining apertures through which forced air can facilitate removal of chaff as grain is being loaded into the grain cart.

### REFERENCE TO RELATED APPLICATIONS

This patent application claims the benefit of U.S. Provisional Patent Application Ser. No. 63/695,575 filed on Sep. 17, 2024, and entitled AIR BLOWER SYSTEMS AND METHODS FOR USE, the disclosure of which is hereby incorporated by reference herein in its entirety.

### TECHNICAL FIELD

The present application relates to air blower systems and methods for using the same. More specifically, the present application relates to an air blower system for agricultural equipment.

### BACKGROUND

Different types of agricultural equipment are used to harvest, process, transport, and store corn, among other crops. For example, corn is often harvested and processed by a combine. Among other things, conventional combines cut down and collect cornstalks, strip ears from stalks and leaves, and separate kernels from cobs, before discarding such stalks, leaves, and cobs. Combines also remove chaff and other impurities from the kernels through, for example, winnowing and other processes. Such chaff includes “bees' wings,” a flaky part of the corn that binds kernels to cobs. Conventional combines may include a fan to facilitate such winnowing, but such fans do not sufficiently separate bees' wings from kernels and many bees' wings remain through this stage of harvesting. As kernels continue to be processed, however, more bees' wings break off from the kernels, creating issues during the transport and storage of corn. For example, excess bees' wings can clog lines and cause ventilation problems in storage equipment. Failure to remove bees' wings can also lead to vomitoxin in corn. It has been shown that that a majority of vomitoxin found in corn samples resides in fines and bees' wings. What is desired is an air blower system that facilitates improved removal chaff, such as bees' wings, from corn and other crops.

### SUMMARY

In accordance with one embodiment, an air blower system includes a blower and an air curtain component in fluid connection with the blower, the air curtain component including an air curtain pipe that is configured to receive air from the blower; wherein the air curtain pipe is configured for placement in or near a grain cart opening, wherein the air curtain pipe includes a plurality of apertures, and wherein the one or more of the plurality of apertures are defined at an angle to direct air received from the blower away from a grain cart interior.

In accordance with another embodiment, a method of using an air blower system includes providing an air blower system on a grain cart, the air blower system including a blower and an air curtain component in fluid connection with the blower, the air curtain component comprising an air curtain pipe, the air curtain pipe having a plurality of apertures and being configured to receive air from the blower; positioning the air curtain pipe, such that one or more of the plurality of apertures are angled away from a grain cart interior; and activating the air blower system, such that air from the blower is forced out of the plurality of apertures to facilitate removal of chaff from grain being fed into the grain cart interior.

In accordance with yet another embodiment, an air blower system includes one or more blowers; an air curtain component comprising an air curtain pipe having a plurality of apertures and being configured to receive air from one of the one or more blowers; wherein the air curtain pipe is configured for placement in or near a grain cart opening, such that one or more of the plurality of apertures are defined at an angle to direct air received from the blower away from a grain cart interior; and vacuum component including a vacuum line in fluid connection with one of the one or more blowers and an interior of a grain cart auger, such that the blower is configured to create a suction force in the vacuum line to pull air from the grain cart auger interior at or near a grain cart auger spout.

### BRIEF DESCRIPTION OF DRAWINGS

The present disclosure will be more readily understood from a detailed description of some example embodiments taken in conjunction with the following figures:

FIG. 1 depicts a perspective view of a combine positioned to unload corn into a grain cart being pulled by a tractor, where the grain cart includes an air blower system, according to one embodiment;

FIG. 2 depicts a perspective view of the grain cart and air blower system of FIG. 1 positioned to unload corn into a grain trailer, where the air blower system includes a vacuum line;

FIG. 3 depicts a cross-sectional view of the grain cart and air blower system of FIG. 1, where a cart auger is in an extended, loading position;

FIG. 4 depicts a cross-sectional view of the grain cart and air blower system of FIG. 1, where the cart auger is collapsed in a folded, transport position;

FIG. 5 depicts a perspective view of the grain cart and air blower system of FIG. 1, where the cart auger is collapsed in a folded, transport position;

FIG. 6 depicts a perspective view of the air blower system of FIG. 1, including a blower with an air flow slide valve that is fully opened;

FIG. 7 depicts a perspective view of the air blower system of FIG. 1, where the slide valve is partially closed;

FIG. 8 depicts a perspective view of an air blower system according to another embodiment, including a blower with a diverter valve;

FIG. 9 depicts a side view of the air blower system of FIG. 8;

FIG. 10 depicts a perspective view of the air blower system of FIG. 1, where a lower vacuum line and an upper vacuum line are disconnected from each other;

FIG. 11 depicts a perspective view of the air blower system of FIG. 1, where the lower vacuum line and the upper vacuum line are connected to each other;

FIG. 12 depicts a perspective view of the air blower system of FIG. 1, where the vacuum line connects to the cart auger;

FIG. 13 depicts a cross-sectional view of the air blower system of FIG. 12, along the line 13-13;

FIG. 14 depicts a perspective view of the air blower system of FIG. 1, including an air curtain pipe;

FIG. 15 depicts a perspective view of the air curtain pipe of FIG. 14;

FIG. 16 depicts a perspective view of an air blower system including an air curtain pipe, according to another embodiment;

FIG. 17 depicts a perspective view of an air blower system including an air curtain pipe, according to another embodiment;

FIG. 18 depicts a front view of a louver system with a plurality of slats shown in an open position, according to one embodiment; and

FIG. 19 depicts a top view of the louver system of FIG. 18.

### DETAILED DESCRIPTION

For the purposes of the present description and of the appended claims, except where otherwise indicated, all numbers expressing amounts, quantities, percentages, and so forth, are to be understood as being modified in all instances by the term “about.” Also, all ranges include any combination of the maximum and minimum points disclosed and include any intermediate ranges therein, which may or may not be specifically enumerated herein.

The present disclosure, in at least one of the mentioned aspects, can be implemented according to one or more of the present embodiments, optionally combined together.

For the purposes of the present description and of the appended claims, the words “a” or “an” should be read to include one or at least one and the singular also includes the plural unless it is obvious that it is meant otherwise. This is done merely for convenience and to give a general sense of the disclosure.

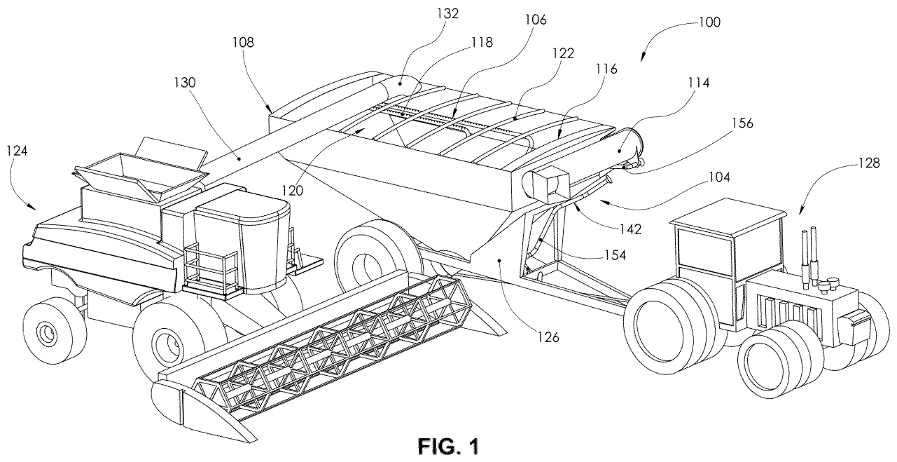

As will be described herein, improved air blower systems are disclosed. Referring to FIGS. 1-4, the air blower system 100 can include a blower 102, which can be configured for connection to one or both of a vacuum component 104 and an air curtain component 106. In certain embodiments, and as shown in FIG. 1, for example, portions of the vacuum component 104 can be mounted to a grain cart 108 on an undercarriage 110, a front side 112, and a cart auger 114. In certain embodiments, the air curtain component 106 can be mounted within an interior 116 of the cart 108 and include an air curtain pipe 118, which is shown in FIG. 1 to be positioned just below a cart opening 120 and cross-members 122 and extending in a direction generally parallel to a length of the cart 108.

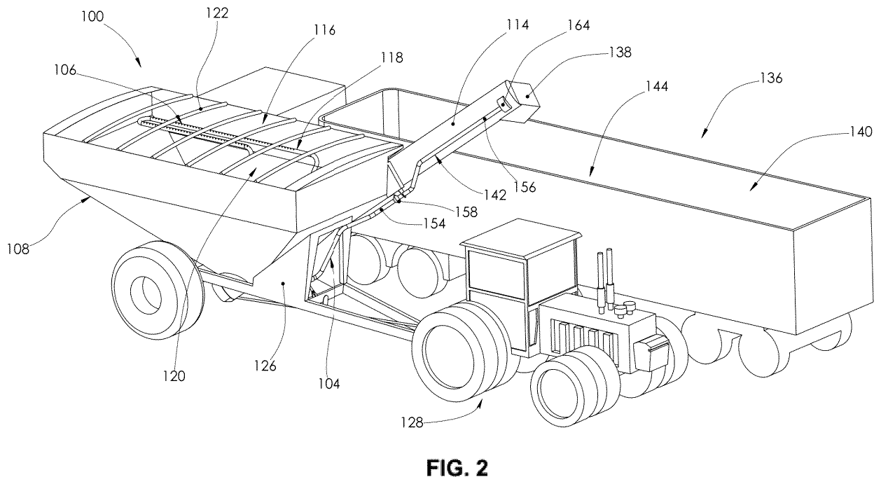

Functions of the air blower system 100 are displayed in each of FIGS. 1 and 2. For example, in FIG. 1, the cart 108 is shown to be disposed alongside a combine 124 in an otherwise conventional arrangement in which the combine 124 is in position to unload corn, or another type of crop or grain (e.g., wheat, rice, canola, beans), into the cart 108. The cart 108 is further shown to include a frame 126, or tongue, that can be connected to a tractor 128, as shown in FIG. 1. The combine 124 can include a combine auger 130 extending from a side thereof, such that a combine auger spout 132 is positioned over the opening 120. In use, as corn, or another type of crop or grain, is dropped from the combine auger spout 132 into the cart interior 116, air from blower 102 is directed to the air curtain component 106, such that it is pushed through air curtain pipe 118 and out of a plurality of apertures 134 provided along a length of the air curtain pipe 118. Such configuration can provide a “curtain” of air that can be directed against the falling corn to facilitate removal of chaff therefrom. In certain embodiments, bees' wings can be among the chaff targeted for removal.

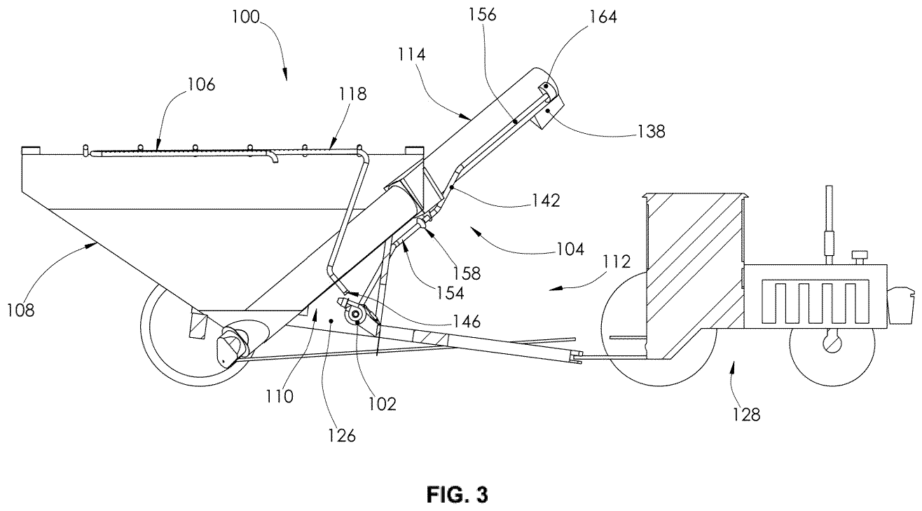

In FIG. 2, the cart 108 is shown to be disposed alongside a grain trailer 136 in an otherwise conventional arrangement in which the cart 108 is in position to unload corn, or another type of crop or grain, into the trailer 136. It will be appreciated, however, that in other embodiments, grains may be unloaded into any of a variety of other movable storage containers, such as a grain wagon. The cart auger 114 can extend from a side of the cart 108, such that a cart auger spout 138 can be positioned over a trailer opening 140. As shown in FIGS. 2 and 3, the vacuum component 104 can include a vacuum line 142 that can extend from the blower 102 in the undercarriage 110 of the cart 108, up the front side 112, along the cart auger 114, and into a top portion of the cart auger 114 at or near the cart auger spout 138. In use, as corn, or another type of crop or grain, is dropped from the cart auger spout 138 into a trailer interior 144, the blower 102 can create a suction force in the vacuum line 142, such that air can be pulled from an interior of the cart auger 114 at or near the cart auger spout 138 and ejected from the blower 102 near the undercarriage 110 of the cart 108. Specifically, the suction can facilitate the removal of chaff from the corn as it is unloaded into the trailer 136. As with the air curtain component 106, bees' wings can be among the chaff targeted for removal by the vacuum component 104.

In certain embodiments, the blower 102 can be a centrifugal fan. And in certain embodiments, the blower 102 can be powered by tractor hydraulics, where hydraulic lines (not shown) can extend from the tractor 128, and along the frame 126, to the blower 102. In certain embodiments, use of the blower 102 can be managed by controls from the tractor 128. It will be appreciated, however, that any of a variety of suitable types of blowers can be used in an air blower system and be powered in any suitable manner.

In certain embodiments, the blower 102 can be pivotable. For example, in such embodiments, the blower 102 can be pivotable between connected and disconnected positions with the air curtain component 106. In FIG. 3, for example, the cart auger 114 is shown to be extended in a loading position, such that the blower 102 can be set for use with the vacuum component 104. Further, it can be further seen from FIG. 3 that blower 102 is in a disconnected position, such that the blower 102 is disconnected from a proximal end 146 of the air curtain pipe 118. Accordingly, in this configuration, the vacuum component 104 of the air blower system 100 may be functional, while the air curtain component 106 is nonfunctional.

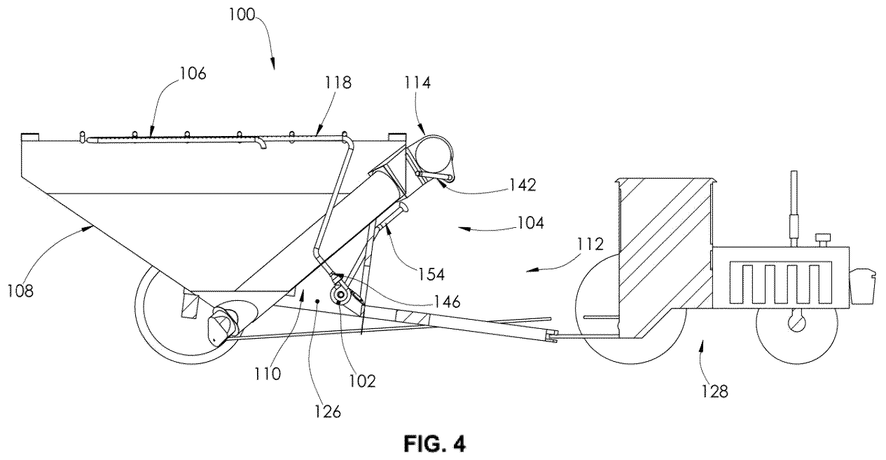

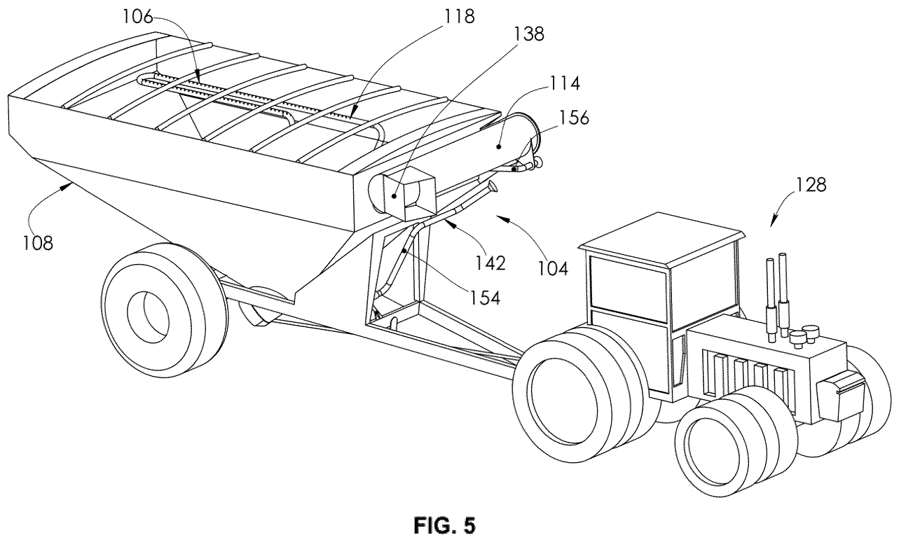

As shown in FIG. 4, the blower 102 is pivoted to a connected position, such that the blower 102 is connected to the proximal end 146 of the air curtain pipe 118. Referring to FIGS. 4 and 5, the cart auger 114 is shown to be folded down in a transport position, such that portions of the vacuum line 142 are disconnected from each other. Accordingly, in this configuration, the air curtain component 106 is functional, while the vacuum component 104 is nonfunctional.

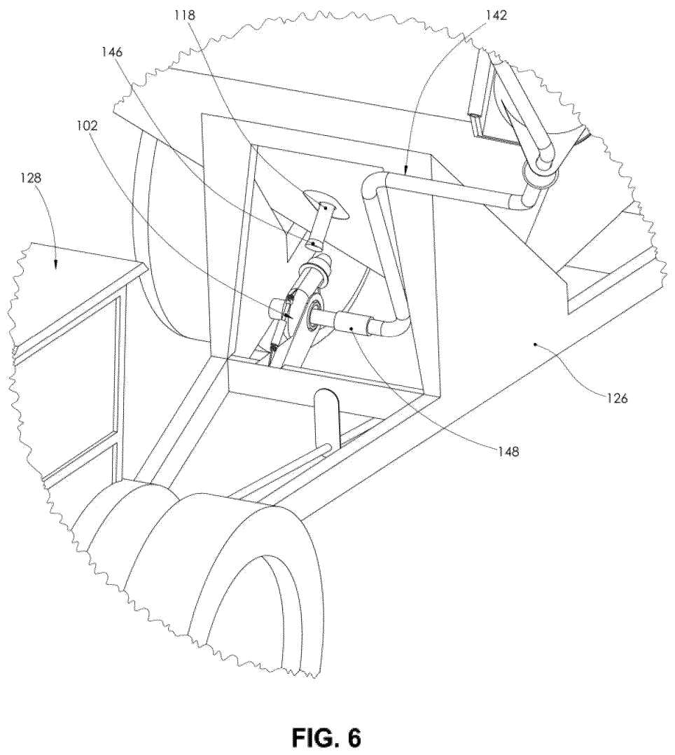

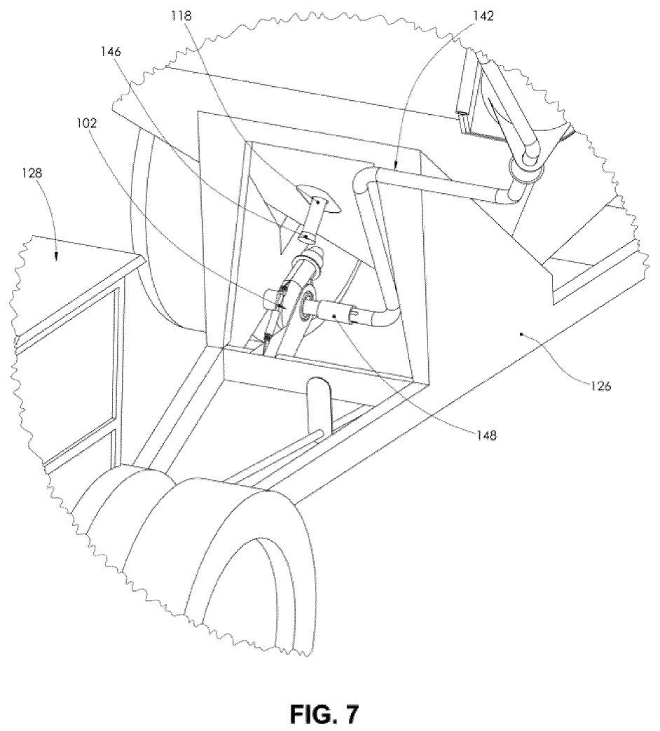

In certain embodiments, and as shown in FIGS. 6 and 7, the blower 102 can further include a sleeve valve 148. The sleeve valve 148 can be positioned on the vacuum line 142 to regulate the suction force exerted on the cart auger spout 138. As shown in FIG. 6, for example, the sleeve valve 148 can be fully slid to one side (e.g., a right side), such that a maximum suction force can be exerted on the cart auger 114. Alternatively, and as shown in FIG. 7, the sleeve valve 148 can be slid in an opposite direction (e.g., a left side), such that a reduced suction force can be exerted on the cart auger 114. It will be appreciated that in certain embodiments, a sleeve valve can be slid between a first position, in which a maximum suction force can be exerted on a cart auger spout and a second position, in which no suction force can be exerted on a cart auger spout. It will further be appreciated that in such embodiments, the sleeve valve can be slid to any point between the first and second positions to increase or decrease the suction force exerted on the cart auger spout.

In certain embodiments, the sleeve valve 148 can be adjusted manually. Such manual adjustment can provide flexibility for the system, particularly where the blower 102, among other components, may be controlled by tractor hydraulics. In other embodiments, however, a sleeve valve may be automated.

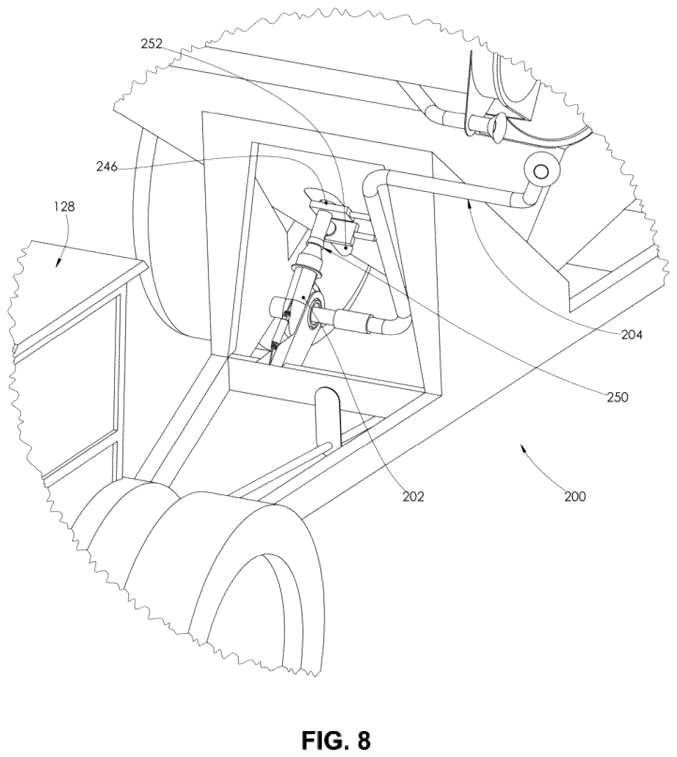

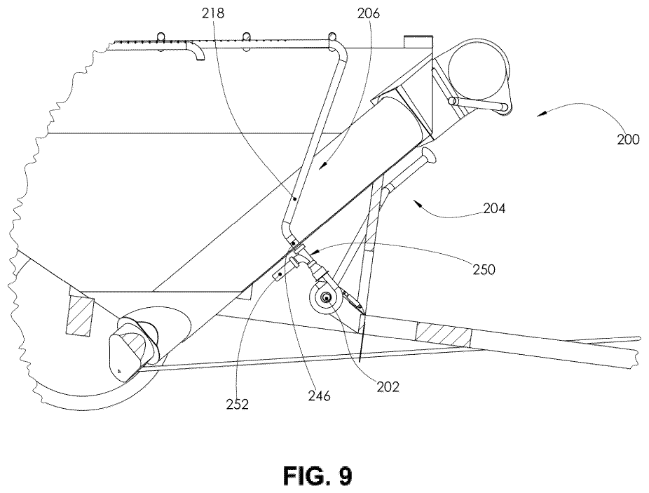

In an alternative embodiment, the blower system 200 can include a blower 202 that is a stationary, i.e., non-pivoting, and remains connected to both a vacuum component 204 and an air curtain component 206. The blower 202 can also be a centrifugal fan and be powered by tractor hydraulics. As shown in FIGS. 8 and 9, the stationary blower 202 can be connected to the air curtain component 206 at a proximal end 246 of an air curtain pipe 218 via a diverter valve 250 or a gate valve. Diverter valve 250 can allow the stationary blower 202 to be used with either of the vacuum component 204 and the air curtain component 206. In certain embodiments, diverter valve 250 can include a switch (not shown) that can change the functionality from one component to another. In such embodiments, the switch may be automated. It will be appreciated, however, that airflow through a blower may be controlled by any of a variety of suitable methods or valve configurations, such that the blower can change between being configured for use with a vacuum component and an air curtain component. In certain embodiments, the diverter valve 250 can further include an exhaust 252, such that when the blower 202 is configured for use with the vacuum component 204, the blower 202 can push through the exhaust 252 any air and chaff collected from a cart auger.

While the FIGS. depict embodiments in which one blower (i.e., a centrifugal fan) is utilized in the air blower system, it will be appreciated that in other embodiments, an air blower system can have two or more blowers, such that at least one blower can be dedicated to a vacuum component and at least one blower can be dedicated to an air curtain component. And while the FIGS. depict embodiments in which the blower is a centrifugal fan, it will be appreciated that other blowers can be utilized in an air blower system.

Referring back to FIGS. 2 and 3, the vacuum component 104 can include a vacuum line 142 that can extend from the blower 102, along the cart 108 and the cart auger 114, to a point on the cart auger 114 that is at or near the cart auger spout 138. The vacuum line 142 can be formed, in certain embodiments, by PVC piping, but it will be appreciated that a vacuum line can be formed from any of a variety of suitable types of piping, hose, tube, or the like. In certain embodiments, a vacuum line can be a continuous line from a blower to a connection point on a cart auger. In other embodiments, however, and as shown, for example, in FIGS. 1-5, the vacuum line 142 can include a lower vacuum line 154, extending from the blower 102, and an upper vacuum line 156, connected to the cart auger 114 and movable therewith. The lower vacuum line 154 and the upper vacuum line 156 can be joined by a coupling 158, as shown, for example, in FIGS. 2 and 3. For example, in certain embodiments, the cart auger 114 can be foldable, such that the cart auger 114 can be movable between an extended, loading position, as shown in FIGS. 2 and 3, and a folded, transport position, as shown in FIGS. 1, 4, and 5. In such embodiments, the lower vacuum line 154 and the upper vacuum line 156 can be disconnected from each other to allow for movement of the cart auger 114 between the extended, loading position and the folded, transport position.

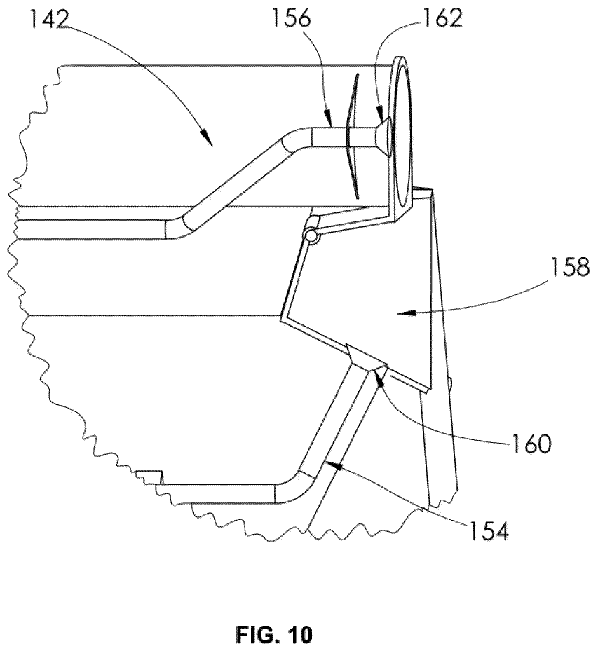

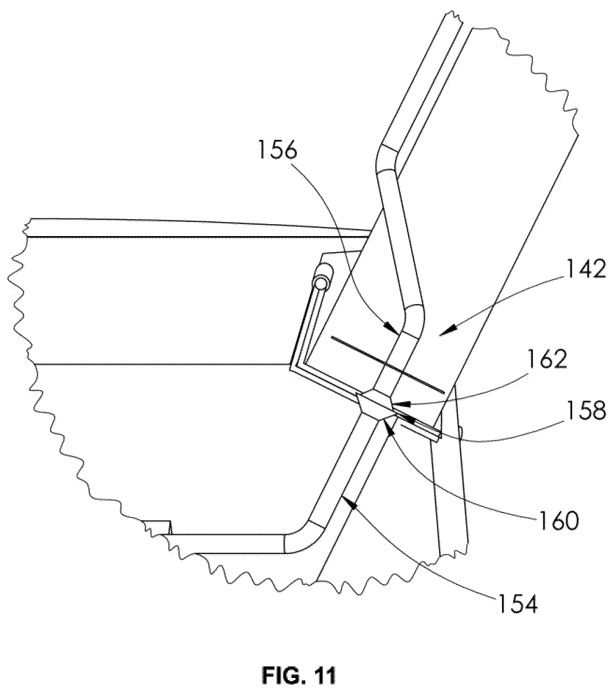

In certain embodiments, the coupling 158 can include a first end 160 extending from the lower vacuum line 154 and a second end 162 extending from the upper vacuum line 156. When the cart auger 114 is moved into the extended, loading position, the first end 160, which can be flared and funnel-shaped, and the second end 162, which can be formed from a rubber ring-shaped gasket, can be joined to form a sealed connection, as shown, for example, in FIGS. 2, 3, and 11. FIGS. 10 and 11 show close-up views of the coupling 158. For example, FIG. 10 shows the coupling 158 in a disconnected position, while FIG. 11 shows the coupling 158 in a connected position. While the air blower system 100 depicted in FIGS. 1-5 shows the vacuum line 142 having the lower vacuum line 154 and the upper vacuum line 156, it will be appreciated that a vacuum line can include any number of segments provided in any of a variety of suitable configurations. It will further be appreciated that segments of a vacuum line can be connectable by any of a variety of suitable connectors.

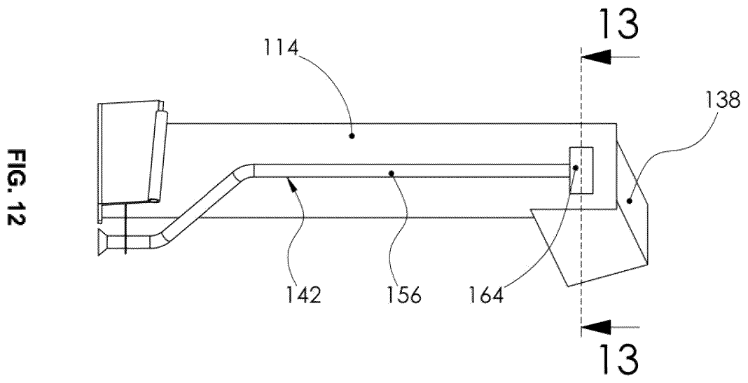

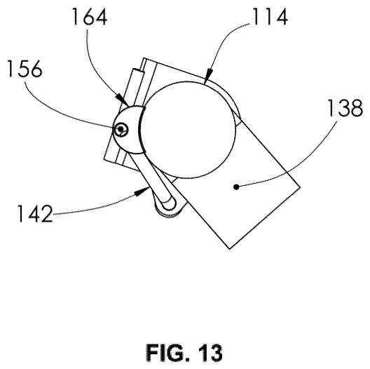

In certain embodiments, the vacuum line 142 can be in fluid connection with an interior of the cart auger 114 at or near the cart auger spout 138. As shown in FIGS. 12 and 13, the vacuum line 142 can be connected to the cart auger 114 via an adapter 164. When the cart auger 114 is in the extended, loading position and the vacuum component 104 is in use, a suction force can be exerted on the interior of the cart auger 114. In certain embodiments, the suction force can be directed to the headspace within the cart auger 114 at or near the cart auger spout 138. An intensity of the suction force can be such that, as corn or another type of crop or grain flows through the cart auger 114 and out of the cart auger spout 138, bees' wings and other lighter chaff in the headspace can be collected by the suction force from the vacuum component 104 without disrupting the flow of corn, or another type of crop or grain. Separating and removing bees' wings and other chaff can further reduce the amount of chaff in the trailer 136 and other, long-term storage containers. Further, removing such chaff in the field can reduce the accumulation of chaff in spaces surrounding the long-term storage containers. Upon removal from the headspace, such chaff can be pulled through the vacuum line 142 and discarded by the blower 102 directly onto the field or surrounding area.

While the vacuum component 104 is shown in the figures to include a vacuum line 142 that is exterior to a grain cart 108, it will be appreciated that, in other embodiments, a vacuum component, or elements thereof, may be positioned in an interior of a grain cart, including a cart auger 114. It will further be appreciated that, in other embodiments, a vacuum component, or elements thereof, can be integrated into a structure of a grain cart.

Referring back to FIGS. 1, 4, and 5, the air curtain component 106 can include an air curtain pipe 118 that can extend from the blower 102 and/or the undercarriage 110 of the cart 108. In certain embodiments, the air curtain pipe 118 can be configured to pass through a window opening in the cart 108. The air curtain component 106 can be configured to receive air into the air curtain pipe 118 from the blower 102. The air curtain pipe 118 can be formed, in certain embodiments, by PVC piping, but it will be appreciated that an air curtain pipe can be formed from any of a variety of suitable types of piping, hose, tube, or the like.

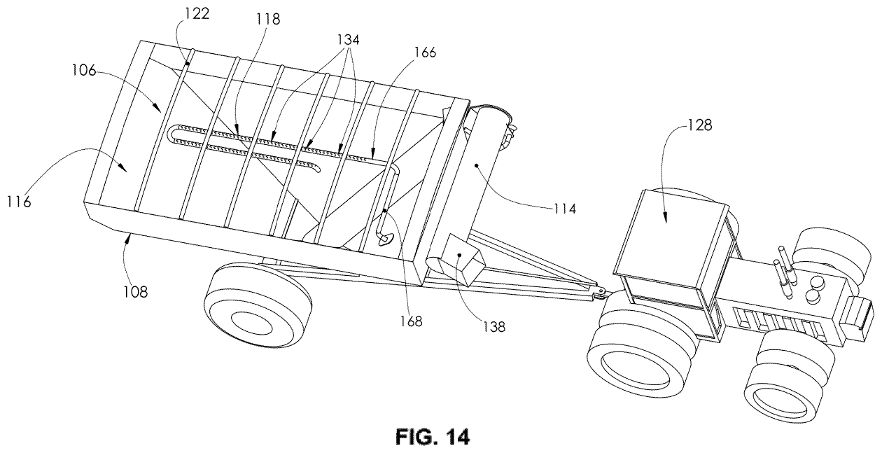

As shown in FIG. 14, the air curtain pipe 118 can include a curtain portion 166 and a bridging portion 168. The curtain portion 166 can include the plurality of apertures 134 organized along a length thereof. The bridging portion 168 can include the proximal end 146 of the air curtain pipe 118 and can span between the blower 102 and the curtain portion 166. In certain embodiments, the bridging portion 168 can be mounted within the interior 116 of the cart 108. In use, air from the blower 102 can proceed through the bridging portion 168 to reach the curtain portion 166, and pressure from the blower 102 can force air into the curtain portion 166 and out of the plurality of apertures 134. The plurality of apertures 134 can be arranged along the air curtain pipe 118 to effect a “curtain” of air to facilitate removal of chaff, including bees' wings, as corn or other crops or grains are loaded into the interior 116 of the cart 108.

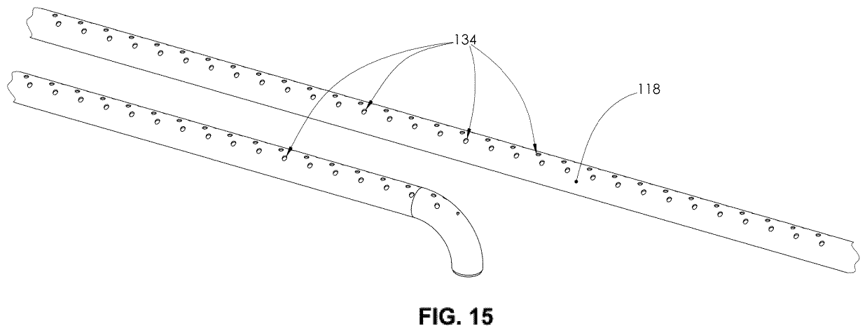

As shown in FIG. 14, for example, the curtain portion 166 can extend at an angle from the bridging portion 168. In certain embodiments, the curtain portion 166 can be configured to extend horizontally or substantially horizontally within the interior 116 of the cart 108. For example, the curtain portion 166 can be configured to lie within or substantially within a plane that is either just below, just above, or coincident with a plane defining the opening 120 of the cart 108. In certain embodiments, the curtain portion 166 can be mounted to or otherwise supported by the cross members 122. In certain embodiments, the plurality of apertures 134 can be defined within the curtain portion 166 at an angle to direct air away from the interior 116 of the cart 108, such that bees' wings and other lighter chaff can be separated from the incoming corn or other crops or grains. While the plurality of apertures 134 are shown in FIGS. 14 and 15 to be organized in a linear manner along a length of the curtain portion 166, it will be appreciated that a plurality of apertures can be organized in any of a variety of suitable configurations on a curtain portion of an air curtain pipe.

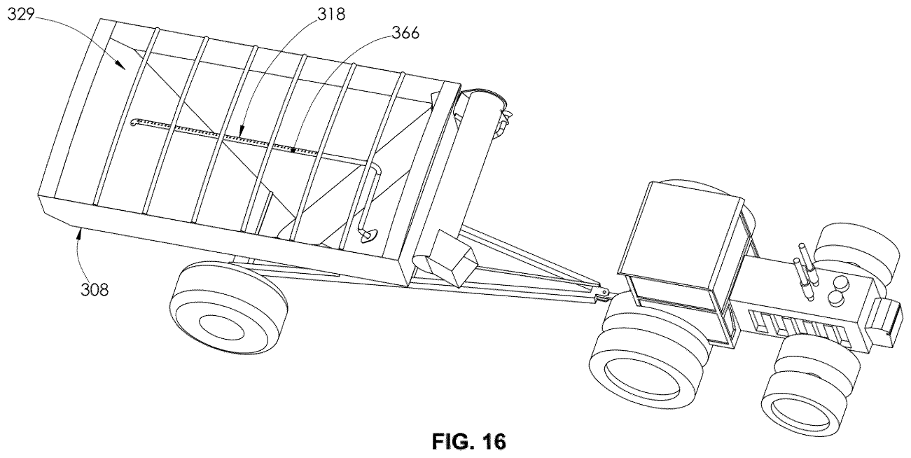

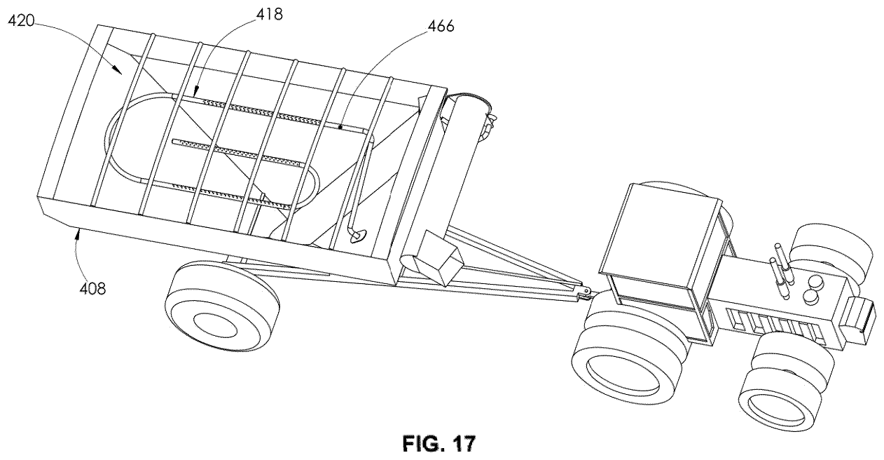

Furthermore, in other embodiments, a curtain portion of an air curtain pipe can be organized in different configurations. FIG. 16, for example, depicts another embodiment of an air curtain pipe 318, in which a curtain portion 366 is arranged in a straight line along a length of an opening 320 of a cart 308. FIG. 17, for example, depicts yet another embodiment of an air curtain pipe 418, in which a curtain portion 466 is arranged in a coil along an opening 420 of a cart 408.

In alternative embodiments, an air curtain component can be used in association with a louver system 570 on a grain cart 508. The louver system 570 can be positioned within or over a cart opening. For example, the louver system 570 can cover or substantially cover the cart opening to better regulate the flow of corn or other crops or grains into the cart 508. The louver system 570 can include one or more sections 572, wherein each section 572 can include a plurality of slats 574. The plurality of slats 574 can be rotated between an open position, in which grain and other crops may be received into the grain cart 508, and a closed position, in which the flow of corn or other crops or grains can be restricted. In use, when in the closed position, the slats 574 can secure corn or other crops or grains within the grain cart 508 and provide protection, for example, from inclement weather. It will be appreciated that a plurality of slats may further be rotated or moved to any position in between an open position and a closed position, and that the plurality of slats may be rotated or moved manually or via automation.

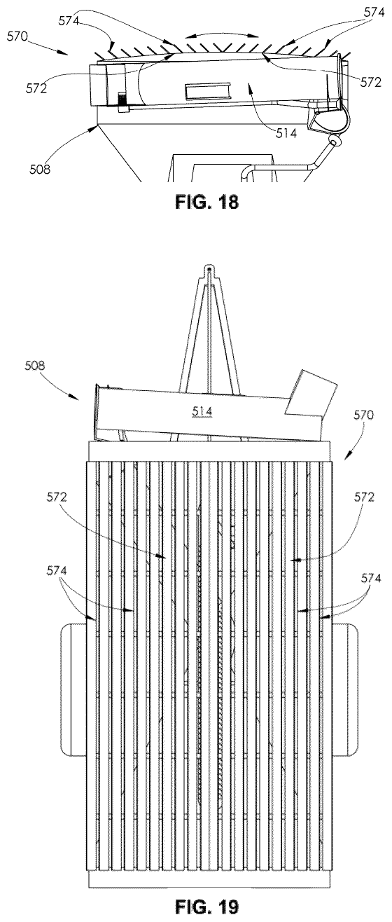

The plurality of slats 574 may be provided in any of a variety of suitable configurations. In certain embodiments, the plurality of slats of one or more sections can be arranged in a direction perpendicular or substantially perpendicular to a length of the cart opening, parallel or substantially parallel to the length of the cart opening, or at any other position. In certain embodiments, the one or more sections can be arranged in any of a variety of suitable configurations. As shown in FIGS. 18 and 19, for example, the louver system 570 can include two sections 572, adjacent to each other in a longitudinal direction, such that each section 572 spans or substantially spans the length of the cart opening, where the plurality of slats 574 in each section 572 can be arranged in a direction parallel or substantially parallel to the length of the cart opening, and where each section 572 is inclined such that each section 572 slopes downward from adjacent ends in a central portion of the cart opening. It will be appreciated, however, that any suitable number of sections can be provided in any of a variety of suitable configurations.

The air curtain component can be mounted to or integrated within the louver system 570. In certain embodiments, an air curtain pipe can be mounted beneath the louver system 574. In alternative embodiments, the air curtain pipe can be integrated within the louver system 574. In use, when mounted beneath and/or integrated within the louver system 574, the air curtain component can be configured to direct forced air, via a plurality of apertures, through and/or along the plurality of slats 574 to facilitate removal of chaff as corn, or other crops or grains, is loaded into the grain cart 508. It will be appreciated that an air curtain pipe can be provided in any of a variety of suitable configurations.

### Examples

Example 1: For each sample, two loads of corn were collected into a grain cart, where each load is about 1,000 bushels. The two loads were taken from adjacent locations within the same field. One load of the sample was subjected to the air blower system, i.e., both the air curtain component and the vacuum component, while the other load was not subjected to the air blower system, or any chaff removal process, while loading into the grain cart and unloading therefrom. A sample from each load was collected in a five-gallon bucket and then processed through a shaker sieve to separate any chaff, e.g., bees' wings and fines, from the corn. The chaff was bagged and weighed for each sample. To allow for a higher chaff content, the combine settings were adjusted such that Samples 1 and 2 were collected with a lower fan speed and a less restrictive sieve configuration than for Samples 3, 4, and 5.

TABLE 1
Amount of Chaff Present in Cleaned
Samples vs. Uncleaned Samples

Weight of Foreign Material (g)

| Sample | Cleaned | Uncleaned |
|---|---|---|
| Sample No. 1 | 82 | 196 |
| Sample No. 2 | 88 | 124 |
| Sample No. 3 | 38 | 74 |
| Sample No. 4 | 42 | 58 |
| Sample No. 5 | 38 | 66 |

As shown in Table 1, above, the corn samples which had been subjected to both the air curtain component and the vacuum component of the air blower system included much less chaff than was present in the uncleaned samples.

Example 2: For each sample, a load of corn was collected into a 1,000 bu.-grain cart. The load was first taken to a grain mill, where a quart-sized sample was subjected to vomitoxin testing. The grain mill ground this sample and added to a solution for an initial vomitoxin reading, i.e., the “uncleaned” result. The same load was later subjected to the air blower system, i.e., both the air curtain component and the vacuum component, before being returned to the same grain mill for vomitoxin testing in the same manner to obtain a second vomitoxin reading, i.e., the “cleaned” result. Testing for samples 6 and 7 was conducted at a first grain mill, while testing for Samples 8 and 9 was conducted at a different grain mill.

TABLE 2
Vomitoxin Content in Cleaned Samples vs. Uncleaned Samples

Vomitoxin Content (ppm)

| Sample | Cleaned | Uncleaned |
|---|---|---|
| Sample No. 6 | 0.67 | 4.6 |
| Sample No. 7 | 2.5 | 2.9 |
| Sample No. 8 | 2.0 | 4.0 |
| Sample No. 9 | 2.6 | 3.9 |

As shown in Table 2, above, the vomitoxin content was lower in the corn samples which had been subjected to both the air curtain component and the vacuum component of the air blower system.

In various embodiments disclosed herein, a single component can be replaced by multiple components and multiple components can be replaced by a single component to perform a given function or functions. Except where such substitution would not be operative, such substitution is within the intended scope of the embodiments.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. An air blower system comprising:
a blower; and
an air curtain component in fluid connection with the blower, the air curtain component comprising an air curtain pipe that is configured to receive air from the blower;
wherein the air curtain pipe is configured for placement in or near a grain cart opening, wherein the air curtain pipe comprises a plurality of apertures, and wherein the one or more of the plurality of apertures are defined at an angle to direct air received from the blower away from a grain cart interior.

2. The air blower system of claim 1, wherein the angle of the plurality of apertures is configured to facilitate removal of chaff from grain being fed into the grain cart.

3. The air blower system of claim 1, wherein the air curtain pipe is mountable within the interior of the grain cart.

4. The air blower system of claim 1, wherein at least a portion of the air curtain pipe is configured to lie within a plane that is just below, just above, or coincident with a plane defining the grain cart opening.

5. The air blower system of claim 1, further comprising a louver system configured for placement within or over the grain cart opening, the louver system comprising a plurality of slats rotatable between an open position, in which grain may be received into the grain cart, and a closed position, in which grain is restricted from entering the grain cart.

6. The air blower system of claim 5, wherein the plurality of slats are configured for placement in a direction parallel or substantially parallel to a length of the grain cart opening and span or substantially span the length of the grain cart opening.

7. The air blower system of claim 6, wherein the louver system comprises two sections, each section being inclined to slope downward from adjacent ends.

8. The air blower system of claim 5, wherein at least a portion of the air curtain pipe is mountable between the louver system and the grain cart.

9. The air blower system of claim 1, further comprising a vacuum component, the vacuum component comprising a vacuum line in fluid connection with the blower and an interior of a grain cart auger, such that the blower is configured to create a suction force in the vacuum line to pull air from the grain cart auger interior at or near a grain cart auger spout to facilitate removal of chaff from grain being unloaded from the grain cart.

10. The air blower system of claim 9, wherein at least a portion of the vacuum line is mountable to the grain cart auger.

11. The air blower system of claim 10, wherein the vacuum line is separable into an upper vacuum line and a lower vacuum line to accommodate movability of the grain cart auger.

12. The air blower system of claim 11, wherein the upper vacuum line and the lower vacuum line are connectable by a coupling comprising a funnel-shaped first end and a ring-shaped second end.

13. The air blower system of claim 10, wherein the vacuum line is in fluid connection with a headspace of the grain cart auger by an adapter.

14. The air blower system of claim 9, wherein the vacuum component further comprises an exhaust, wherein the blower can push through the exhaust any air and chaff collected from the grain cart auger interior.

15. A method of using an air blower system, the method comprising:
providing an air blower system on a grain cart, the air blower system comprising:
a blower; and
an air curtain component in fluid connection with the blower, the air curtain component comprising an air curtain pipe, the air curtain pipe having a plurality of apertures and being configured to receive air from the blower;
positioning the air curtain pipe, such that one or more of the plurality of apertures are angled away from a grain cart interior; and
activating the air blower system, such that air from the blower is forced out of the plurality of apertures to facilitate removal of chaff from grain being fed into the grain cart interior.

16. The method of claim 15, further comprising providing a vacuum component on the grain cart, the vacuum component comprising a vacuum line in fluid connection with the blower and an interior of a grain cart auger; and
activating the air blower system, such that the blower creates a suction force in the vacuum line to pull air from the grain cart auger interior at or near a grain cart auger spout to facilitate removal of chaff from grain being unloaded from the grain cart.

17. An air blower system comprising:
one or more blowers;
an air curtain component comprising an air curtain pipe having a plurality of apertures and being configured to receive air from one of the one or more blowers; wherein the air curtain pipe is configured for placement in or near a grain cart opening, such that one or more of the plurality of apertures are defined at an angle to direct air received from the blower away from a grain cart interior; and
a vacuum component comprising a vacuum line in fluid connection with one of the one or more blowers and an interior of a grain cart auger, such that the blower is configured to create a suction force in the vacuum line to pull air from the grain cart auger interior at or near a grain cart auger spout.

18. The air blower system of claim 17, wherein the one or more blowers comprises a first blower being in releasable and alternative fluid connectable with the air curtain pipe and the vacuum line.

19. The air blower system of claim 17, wherein the one or more blowers comprises a first blower being in fluid connection with both the air curtain pipe and the vacuum line.

20. The air blower system of claim 17, wherein the one or more blowers comprises a first blower in fluid connection with the air curtain pipe; and a second blower in fluid connection with the vacuum line.
